(19) United States
(12) Patent Application Publication
(10) Pub. No.: US 2013/0072174 A1
(43) Pub. Date: Mar. 21, 2013

(54) METHOD AND APPARATUS FOR DISABLING CERTAIN COMMUNICATION FEATURES OF A VEHICLE DRIVERS WIRELESS PHONE

(71) Applicants: Don Enty, Colleyville, TX (US); Brett Barta, Hudson, OH (US)

(72) Inventors: Don Enty, Colleyville, TX (US); Brett Barta, Hudson, OH (US)

(21) Appl. No.: 13/431,067

(22) Filed: Mar. 27, 2012

Related U.S. Application Data
(60) Provisional application No. 61/469,544, filed on Mar. 30, 2011.

(51) Int. Cl. H04W 4/02

(52) U.S. Cl. CPC H04W 4/027
USPC 455/418

(57) ABSTRACT

A method and an apparatus for disabling certain features of a vehicle driver's wireless device include a control module strategically mounted within a vehicle passenger compartment, i.e., beneath the steering wheel. The module includes a Bluetooth device that activates a wireless-transmission device upon the slightest movement of the vehicle. The driver's wireless phone is loaded with an application that disables the ability of the user to receive emails, SMS messages or other data upon receipt of a discrete wireless signal from the transmission device. Accordingly, when the ignition is activated and the vehicle moves, the text-transmission feature is disabled. A remote server may be utilized to monitor the wireless device and notify a parent or manager if the user attempts to disable the software application.

### CROSS REFERENCE TO RELATED APPLICATIONS

This application is entitled to the benefit of provisional application No. 61/469,544 filed on Mar. 30, 2011, which is incorporated herein by reference.

### BACKGROUND OF THE INVENTION

The present invention relates to a device for automatically disabling communication features, such as the text-message transmission, of a vehicle driver's wireless phone or device.

### DESCRIPTION OF THE PRIOR ART

Transmitting text messages from a wireless phone (i.e., “texting”) while driving is extremely dangerous and cause numerous traffic accidents each year. In fact, many studies suggest that such practice is more perilous than operating a vehicle while intoxicated or impaired. As a result, many jurisdictions have attempted to ban texting while driving, but with minimal success.

Accordingly, there is currently a need for a device that prevents a driver from transmitting wireless text messages while driving. The present invention satisfies this need by providing a control module that wirelessly disables a designated wireless-phone's text-transmission capabilities in response to vehicle movement.

### SUMMARY OF THE INVENTION

The present invention relates to a method and apparatus for disabling certain features of a vehicle driver's wireless phone. The apparatus includes a control module strategically mounted within a vehicle passenger compartment, i.e., beneath the steering wheel.

The control module includes a GPS monitor that activates a wireless-transmission device upon the slightest movement of the vehicle. The driver's wireless phone is loaded with a software application that disables the text-transmission feature upon receipt of a discrete wireless signal from the transmission device. Accordingly, when the ignition is activated and the vehicle moves, the text-transmission feature is disabled. When the vehicle is stationary, the command signal is disabled and the text-transmission feature may be reactivated.

It is therefore an object of the present invention to provide a device that automatically disables certain distracting features of a wireless phone whenever a vehicle is moving.

It is another object of the present invention to provide a device that enhances vehicle safety.

Another object of the present invention is to provide an apparatus for disabling a communication feature of a vehicle driver's wireless device comprising a control module mounted within a vehicle passenger compartment, means for transmitting a discrete wireless signal to the wireless device, and means for disabling a select communication feature on the wireless phone upon receipt of the discrete wireless signal.

Another object of the present invention is provide an apparatus further comprising a sensing means within the control module for detecting movement of a vehicle, the sensing means being in wireless communication with the wireless device.

Another object of the present invention is provide an apparatus where in the sensing means comprises an ultra-sensitive motion sensor.

Further, another object of the present invention is to provide an apparatus where in the motion sensor is a GPS module.

Still yet, another object of the present invention is to provide an apparatus, wherein the means for transmitting a discrete wireless signal comprises a wireless transmitter in communication with the wireless device.

Further yet, another object of the present invention is provide an apparatus further comprising a voyage tracking means for creating an accessible record of vehicle activity.

Still, another object of the present invention is to provide an apparatus further comprising means for transmitting an alert message to a second communication device in the event the means for disabling a select communication feature is deactivated, wherein a supervisor is notified to view the alert message via the second communication device.

Another object of the present invention is a method of disabling a communication feature of a vehicle driver's wireless phone comprising the steps of installing a control module within a vehicle, transmitting a wireless signal to the wireless phone upon the sensor detecting movement of the vehicle, and disabling a select communication feature on the wireless phone upon receipt of the wireless signal.

Another object of the present invention is to provide a method further comprising the step of installing a motion sensor within the vehicle.

Another object of the present invention is to provide a method further comprising the steps of recording and tracking vehicle activity.

Another object of the present invention is provide a method further comprising the steps of transmitting an alert message to a second communication device in the event that disabling the select communication feature is not possible; and receiving the alert message by a supervisor.

Another object of the present invention is provide an apparatus for disabling a communication feature of a device comprising a control module mounted within a vehicle passenger compartment having a wireless transmission device, and a disabling means operatively associated with the device, wherein the disabling means is adapted to deactivate at least one communication feature of the device.

Another object of the present invention is to provide an apparatus wherein the device is a wireless communication device.

Another object of the present invention is to provide an apparatus wherein the at least one communication feature is selected from the group comprising email, internet access, data transmission, and SMS messaging.

Further, another object of the present invention is to provide an apparatus further comprising a notification means in operative communication with the disabling means.

Further, another object of the present invention is to provide an apparatus wherein the notification means further comprises data information, wherein the data information is adapted to be sent to a second communication device.

Another object of the present invention is provide an apparatus wherein the data information is selected from the group comprising vehicle speed, vehicle location, interruption of disablement means, curfew violation, and exceeding permitted geographical radius.

Another object of the present invention is to provide an apparatus wherein the second communication device is a computer or hand held device such that a parent or supervisor is notified to intercept the data information.

Another object of the present invention is to provide an apparatus wherein the hand held device may be a portable media device, wireless phone, a smartphone, an iPod, or a wireless tablet.

Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a schematic view of the present invention.

FIG. 2 depicts a vehicle passenger compartment with the control module according to the present invention installed therein.

FIG. 3 is a top view of the passenger compartment of FIG. 1.

FIG. 4 is an isolated view of the control module.

FIG. 5 is a schematic of the control module's internal components.

FIG. 6 is a flow chart illustrating the present invention.

FIG. 7a is a schematic illustrating one aspect of the present invention.

FIG. 7b is a schematic illustrating another aspect of the present invention.

FIG. 8 is a schematic illustrating another aspect of the present invention.

### DESCRIPTION OF THE PREFERRED EMBODIMENT

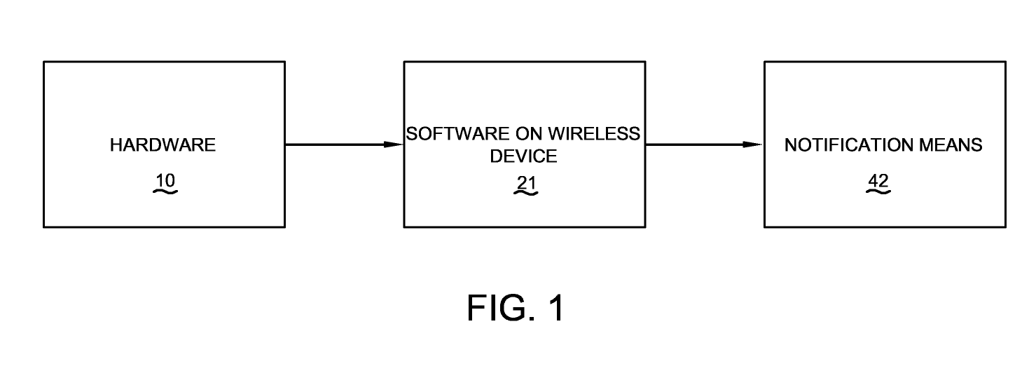

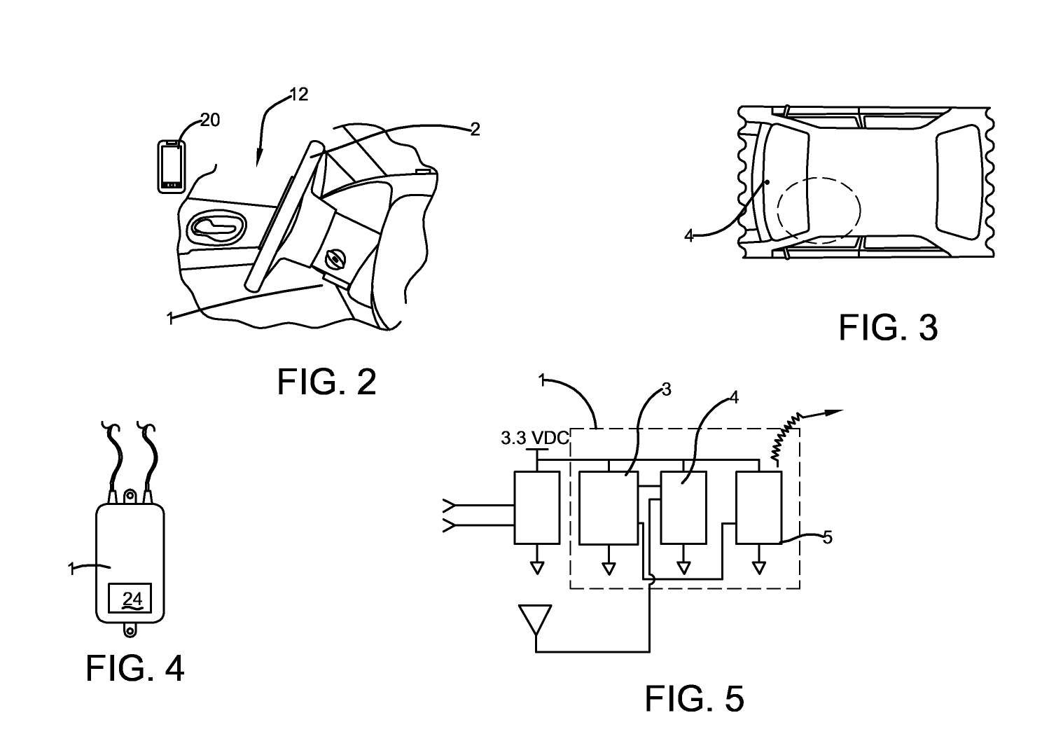

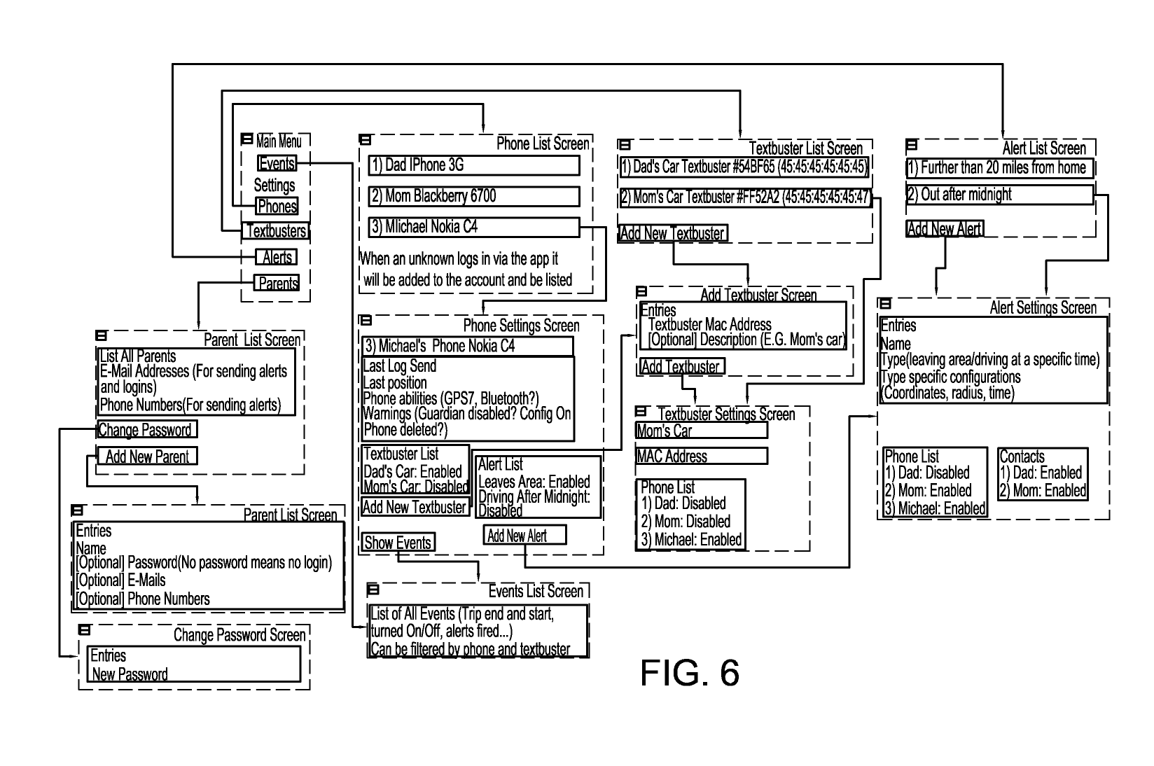

The present invention is illustrated in FIGS. 1-8. The present invention relates to a method and apparatus for disabling certain features of a vehicle driver's wireless device 20, such as a cellphone, smartphone, tablet or similar device that is capable of sending or receiving data, when an associated vehicle is in motion. Generally, the invention may comprise three central components: 1) the hardware apparatus 10; 2) a downloadable software application 21 on the user's wireless device 20; and 3) an optional back end server software (notification means 42), that may compile and provide data information about the associated wireless device 20 to a third person located externally of the vehicle.

The apparatus 10 includes a control module 1 strategically mounted within a vehicle passenger compartment 12, such as, beneath a steering wheel 2. The control module 1 may be mounted anywhere within the vehicle passenger compartment 12. In one embodiment, it may be optimal to have the control module 1 mounted in close proximity to a fuse panel (not shown).

The wireless transmission device 5 may be either a radio-frequency (RF) data link or a low-range communication package, such as that commonly marketed and sold under the trademark BLUETOOTH™ 16. The driver's wireless device 20 is loaded with a software application 21 that disables data transmission of data information 44 upon receipt of a discrete wireless signal from the transmission device 5. Examples of data information 44 may include without limitation, email, internet access, and SMS messaging. Furthermore, the software application 21 could be configured to disable other phone features, such as outbound dialing or all data functions. It should be understood that disabling the data information 44 is only temporary. Once the pairing between the software application 21 and the wireless transmission device 5 is broken, blocked data information 44 is delivered to the wireless device 20.

Upon movement of the vehicle, the wireless transmission 5 device sends the wireless signal to the wireless device 20 in order to disable data transmission of data information 44. In order to determine movement of the vehicle, the wireless transmission device 5 works with the wireless device's 20 internal global positioning system (“GPS”) to determine movement of the vehicle. If the accuracy of the phone's GPS system is insufficient, an accelerometer may be installed within the control module to detect movement. In another embodiment, the control module 1 may include a computer 3 or power supply board programmed to control an ultra-sensitive motion sensor 24 and a wireless transmission device 5. The motion sensor 24 may be preferably a wide-area augmentation system (WASS) GPS module 4 that detects even slight vehicle movement.

Accordingly, a driver pairs a discrete wireless device 20 with the control module 1 in a conventional fashion. The pairing could be manual or automatic, but it preferably performed only on the driver's device 20 so that the passengers' devices 20 are unaffected. In one embodiment, when the ignition is activated and the vehicle moves, the GPS will instruct the control computer 3 to transmit the wireless command signal to the paired wireless device 20. Upon receipt of the wireless signal, the software application 21 immediately disables the pertinent communication feature. In one embedment, when the vehicle is stationary, the command signal is disabled and the text-transmission feature is reactivated. In another embodiment, the data transmission may remain deactivated.

Preferably, the software application 21 is protected by a master password that allows a parent or supervisor to control and configure applicable settings. Furthermore, the master password allows access to a voyage log created by the software 21 so that a supervisor can monitor vehicle activity.

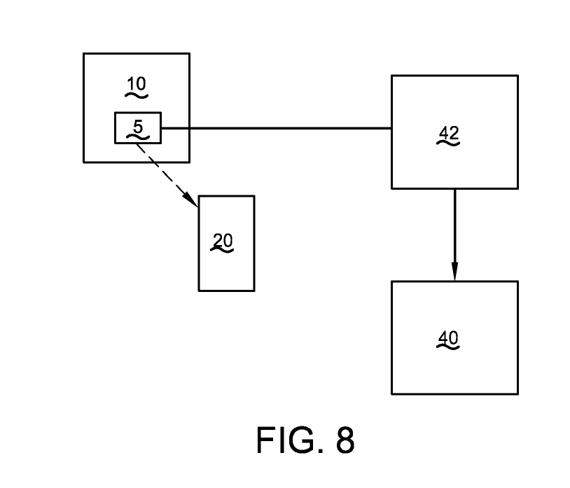

In another embodiment of the present invention, notification means 42 may be utilized with the present invention as shown in FIG. 8. The notification means 42 may take the form of a back end server having software that may include automated text-message and email-transmission capabilities. Upon detection of disablement of the software application 21, the pairing connection or the wireless device 20, the transmission device 5 sends a signal to the notification means 42, which automatically transmits an alert to a second communication device 40, such as a computer or hand held device (wireless phone, tablet or media player). A third party external to the vehicle, such as a parent, fleet manager or supervisor, having the second communication device is able to intercept the alert. The alert may contain any type of information, including but not limited to vehicle speed, vehicle location, interruption of disablement means (pairing connection), curfew violation, and exceeding permitted geographical radius.

The above-described device is not limited to the exact details of construction and enumeration of parts provided herein. Furthermore, the size, shape and materials of construction of the various components can be varied.

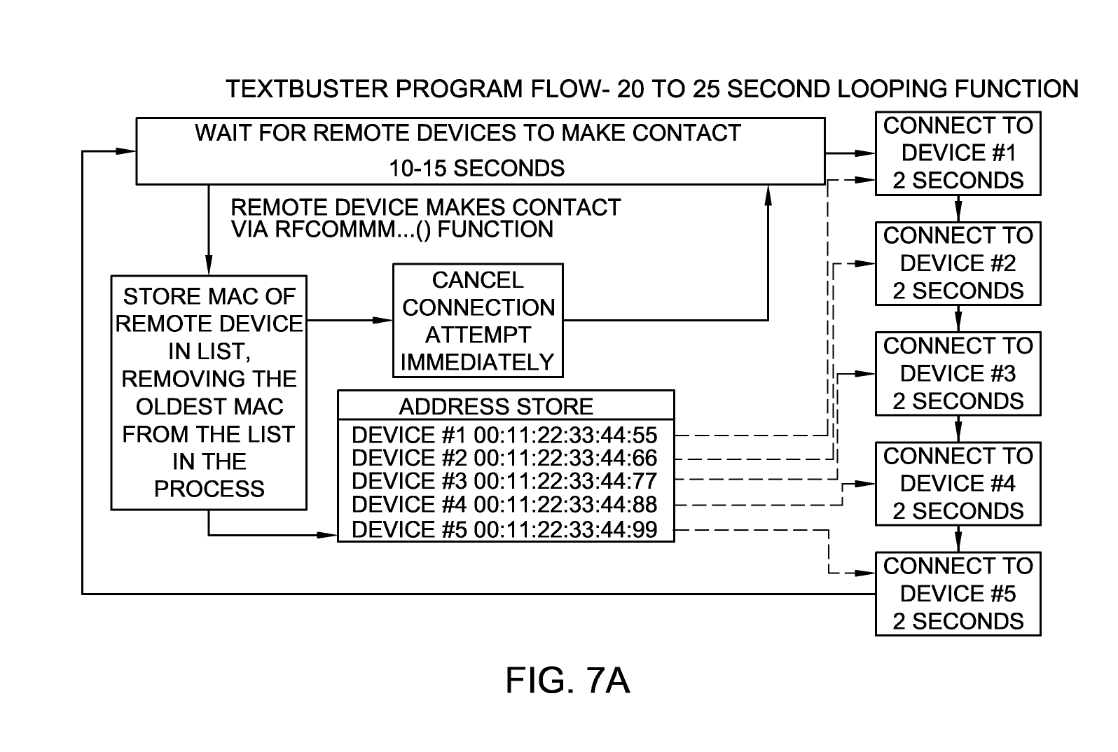

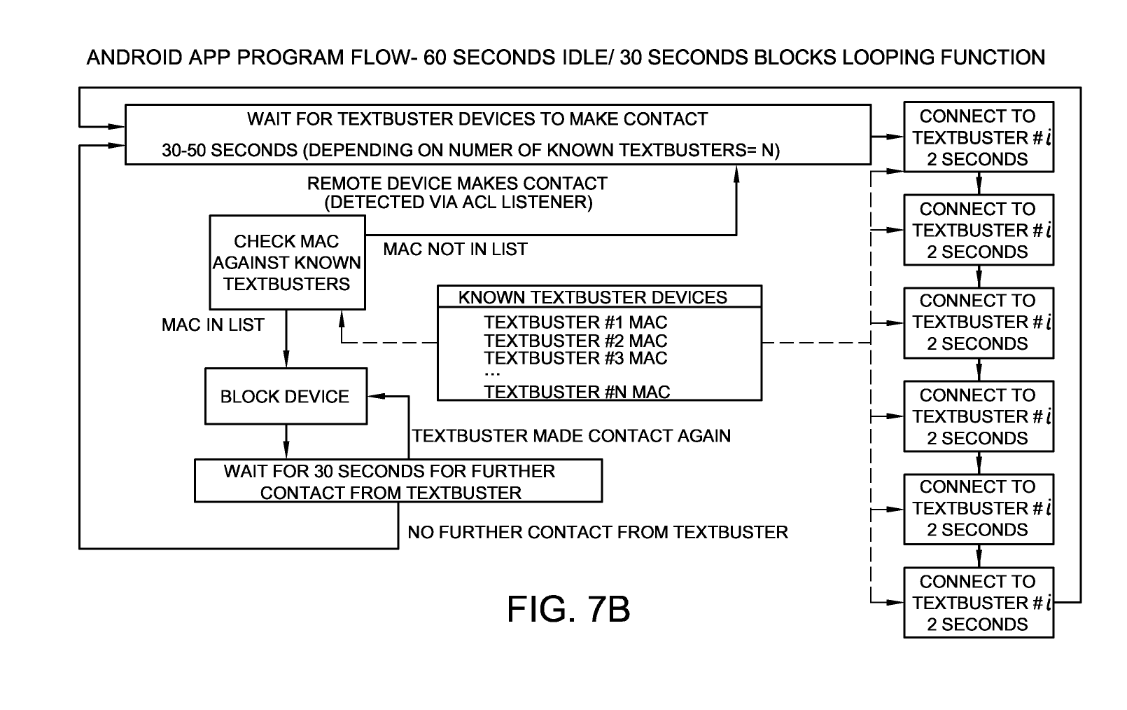

The means for transmitting the signal 14 will now be further described. As previously described, one such example of the signal transmission means is the Bluetooth device 16. With reference to FIGS. 7a and 7b, the transmission device 5 (Bluetooth device 16) may run in an infinite loop, repeating a pattern which is about 20-26 seconds long. Any length of time may be utilized for the infinite loop, for example a ten second loop or a sixty second loop. The pattern alternates between a 10-second long sending phase and a 10 to 16-second long discovery phase. During the sending phase, five 2-second long asynchronous connection-oriented logical transport (“ACL”) connection attempts are made to five different wireless device 20 Bluetooth devices 16. The addresses are stored internally in an address list stored in the control module 1. The apparatus 10 should select the next address which has not been contacted for the longest time.

During the discovery phase, the apparatus waits for about 10-16 seconds for wireless devices 20 running the disabling means 18, such as the software application 21, to make an ACL connection attempt. Once a new device 20 is discovered and its address known to the apparatus 10, the new address is stored in one of the five slots on an internal list while the oldest entry in the list is overwritten with the new one.

The apparatus 10 should stop the pattern and become discoverable for 30 seconds when a button on the apparatus 10 is pressed, so that the software application 21 can determine the address and descriptor (e.g. “Textbuster #3A54B5”) during application setup. After the 30 seconds, the pattern will continue as previously described. If the device has less than five addresses in its list, it will reuse Address 1, 2, . . . to fill the empty time slots in the sending phase.

If the Bluetooth device 16 has contacted the wireless device 20 in the last 30 seconds, the software application 21 will keep the wireless device 20 and Bluetooth device 16 idle awaiting further connection attempts by the Bluetooth device 16.

If the apparatus 10 fails to make a connection attempt for 30 seconds, the software application 21 will proceed with the following looping pattern. The device will try to create an RFCOMM connection with each apparatus 10 whose address it stored. Addresses are configurable via the software application 21 or via discovering the apparatus 10 when it is in its 30 second discoverable mode. The software application 21 will try to connect five apparatuses for 2 seconds each, then repeat this step with the same five addresses, so it hits the time window of the apparatus' discovery phase. The software application 21 will try to send the apparatus' 1-Bluetooth device 16 into idle mode after all apparatuses were contacted twice for the remaining seconds of a full minute. If the software application 21 knows less than five addresses, it will be idle for 2 seconds per empty “Contact Textbuster” slot to preserve battery life.

In summary, the apparatus 10 sends a blocking signal via the Bluetooth device 16 to a person's wireless device 20. This may be done automatically every time the user enters the associated vehicle. The software application 21 downloaded to the wireless device 20 recognized the signal from the apparatus 10 and prevents data information 44 from being used on the wireless device 20. One exception may be the making and receiving of phone calls. The software application 21 may utilize the wireless device's 20 internal GPS software to determine movement of the vehicle. The apparatus 10, via the Bluetooth device 16, may disable a plurality of wireless devices simultaneously. The Bluetooth device 16 attempts to pair a wireless device 20 having the software application 21 at a regular time interval, such as every second.

Although there has been shown and described the preferred embodiment of the present invention, it will be readily apparent to those skilled in the art that modification may be made thereto which do not exceed the scope of the appended claims. Therefore, the scope of the invention is only to be limited by the following claims.

What is claimed is:

1. An apparatus for disabling a communication feature of a vehicle driver's wireless device comprising:
a control module mounted within a vehicle passenger compartment;
means for transmitting a discrete wireless signal to the wireless device; and,
means for disabling a select communication feature on said wireless phone upon receipt of said discrete wireless signal.

2. The apparatus according to claim 1 further comprising a sensing means within said control module for detecting movement of a vehicle, said sensing means being in wireless communication with said wireless device.

3. The apparatus according to claim 2 wherein said sensing means comprises a motion sensor.

4. The apparatus according to claim 3 wherein said motion sensor is a GPS module.

5. The apparatus according to claim 1 wherein said means for transmitting a discrete wireless signal comprises a wireless transmitter in communication with said wireless device.

6. The apparatus according to claim 1 further comprising a voyage tracking means for creating an accessible record of vehicle activity.

7. The apparatus according to claim 1 further comprising means for transmitting an alert message to a second communication device in the event said means for disabling a select communication feature is deactivated, wherein a supervisor is notified to view said alert message via said second communication device.

8. A method of disabling a communication feature of a vehicle driver's wireless phone comprising the steps of:
installing a control module within a vehicle;
transmitting a wireless signal to said wireless phone upon movement of said vehicle;
disabling a select communication feature on said wireless phone upon receipt of said wireless signal.

9. The method of claim 8, further comprising the step of:
installing a motion sensor within said vehicle.

10. The method according to claim 8 further comprising the steps of recording and tracking vehicle activity.

11. The method according to claim 8 further comprising the steps of:
transmitting an alert message to a second communication device in the event that disabling the select communication feature is not possible; and
receiving said alert message by a supervisor.

12. An apparatus for disabling a communication feature of a device comprising:
a control module mounted within a vehicle passenger compartment having a wireless transmission device; and
disabling means operatively associated with said device, wherein said disabling means is adapted to deactivate at least one communication feature of said device upon movement of an associated vehicle.

13. The apparatus of claim 12, wherein said device is a wireless communication device.

14. The apparatus of claim 12, wherein said at least one communication feature is selected from the group comprising email, internet access, data transmission, and SMS messaging.

15. The apparatus of claim 12, further comprising notification means in operative communication with said disabling means.

16. The apparatus of claim 15, wherein said notification means further comprises data information, wherein said data information is adapted to be sent to a second communication device external to the vehicle.

17. The apparatus of claim 16, wherein said data information is selected from the group comprising vehicle speed, vehicle location, interruption of disablement means, curfew violation, and exceeding permitted geographical radius.

18. The apparatus of claim 15, wherein said second communication device is a computer or hand held device such that an associated person external to the vehicle is adapted to intercept said data information.

19. The apparatus of claim 12, wherein said disabling means of said device is a computer software application.

20. The apparatus of claim 19, wherein said device further comprises a global positioning system and said global positioning system operatively communicates with said computer software application to determine movement of the vehicle.
